(19) United States
(12) Patent Application Publication
(10) Pub. No.: US 2005/0007232 A1
(43) Pub. Date: Jan. 13, 2005

(54) Magnetic core and coil component using the same

(75) Inventors: Kazuyuki Ono, Sendai-shi (JP); Takashi Yanbe, Sendai-shi (JP); Hatsuo Matsumoto, Sendai-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: NEC TOKIN CORPORATION, Sendai-shi (JP)

(21) Appl. No.: 10/866,498

(22) Filed: Jun. 10, 2004

(30) Foreign Application Priority Data
Jun. 12, 2003 (JP) 2003-168055
Jun. 17, 2003 (JP) 2003-172313
Jun. 27, 2003 (JP) 2003-185303
Aug. 6, 2003 (JP) 2003-206300
Sep. 16, 2003 (JP) 2003-323673
Oct. 21, 2003 (JP) 2003-360606
Nov. 28, 2003 (JP) 2003-399664
Feb. 10, 2004 (JP) 2004-033576
Mar. 8, 2004 (JP) 2004-063989
May 17, 2004 (JP) 2004-146858

(51) Int. Cl. H01F 27/24

(52) U.S. Cl. 336/213

(57) ABSTRACT

A magnetic core is obtained by hardening or curing a mixture of magnetic powder and resin. The magnetic core shows a superior DC bias characteristic which does not become drastically saturated but is gently saturated even beyond 1000*10³/4π [A/m]. Therefore, the magnetic core has sufficient relative permeability more than ten.

### BACKGROUND OF THE INVENTION

This invention relates to a magnetic core and a coil component using the same. In particular, his invention relates to the magnetic core for the coil component which is used as a reactor in a high-power system such as an energy control of a battery mounted on an electrically-powered car or a hybrid car including an electromotor and an internal-combustion engine.

A known coil component is disclosed in JP-A2001-185421. The disclosed coil component is used for a low-power system. The disclosed coil component comprises a coil and first and second magnetic core members. The first magnetic core member includes magnetic metal powder of 50-70%, by volume, and thermosettable resin of 50-30%, by volume. The second magnetic core member is a dust core made of sintered ferrite body or magnetic metal powder. The first and the second magnetic core members are magnetically connected in series. The coil is embedded in the first magnetic core member.

One of the purposes of JP-A 2001-185421 is to provide a magnetic component such as an inductor, a choke coil and a transformer, which is suitable for use in a large-current electronic component.

However, note here that the term “large current” is a relative term. The actual target of an electric current range of JP-A 2001-185421 is from several amperes to several tens of amperes as disclosed in paragraph [0002] of JP-A 2001-185421. In addition, because a coil component is normally designed to have a better DC bias characteristic in its target electric-current range, i.e. the range from several amperes to several tens of amperes in JP-A2001-185421. Furthermore, according to conventional techniques, beyond the target electric-current range, its DC bias characteristic becomes drastically saturated and its relative permeability becomes lowered.

On the other hand, in a high-power system such as an energy control of a battery mounted on an electrically-powered car or a hybrid car, a coil component is used in an electric current of two hundreds amperes or more. It is therefore conceivable that the coil component of JP-A 2001-185421 is not suitable for the high-power system.

### SUMMARY OF THE INVENTION

It is therefore an object of the present invention to provide a magnetic core, which is suitable for use in a high-power coil component, and to provide a coil component using the magnetic core.

According to one aspect of the present invention, a magnetic core is a core obtainable by hardening a mixture of magnetic powder and resin. The magnetic core shows a superior DC bias characteristic which does not become drastically saturated but is gently saturated even beyond 1000*10³/4π [A/m]. Therefore, the magnetic core has sufficient relative permeability more than ten at a magnetic field of 1000*10³/4π [A/m].

According to another aspect of the present invention, a coil component comprises the aforementioned magnetic core and a coil wound around the magnetic core.

According to another aspect of the present invention, another coil component comprises the magnetic core made of the mixture and a coil, wherein the magnetic core is arranged in the vicinity of the coil to constitute at least one part of a magnetic path in relation to the coil.

According to another aspect of the present invention, another coil component comprises the magnetic core made of the mixture and a coil, wherein at least one part of the coil is embedded in the magnetic core.

An appreciation of the objectives of the present invention and a more complete understanding of its structure and a fabrication method thereof may be had by studying the following description of the preferred embodiment and by referring to the accompanying drawings.

### BRIEF DESCRIPTION OF THE DRAWINGS:

FIG. 1 is a graph showing a DC bias characteristic of a magnetic core according to an embodiment of the present invention, wherein the magnetic core is made of a mixture of resin and magnetic powder;

FIG. 2 is a perspective view showing a coil component using the magnetic core made of the mixture;

FIG. 3 is a perspective view showing another coil component using the magnetic core made of the mixture;

FIG. 4 is a perspective view showing another coil component using the magnetic core made of the mixture, wherein another magnetic core is inserted in the magnetic core made of the mixture;

FIG. 5 is a perspective view showing another coil component using the magnetic core made of the mixture, wherein a high magnetic reluctance member is inserted in the magnetic core made of the mixture;

FIG. 6 is a cross-sectional view showing a structure of a coil insulated;

FIG. 7 is a perspective view showing another coil component using the magnetic core made of the mixture, wherein the coil component is enclosed in a rectangular parallelepiped case; and

FIG. 8 is a partially-sectional, perspective view showing another coil component using the magnetic core made of the mixture, wherein the coil component is enclosed in a spherical case.

### DESCRIPTION OF PREFERRED EMBODIMENTS

According to an embodiment of the present invention, a magnetic core is made of a mixture of magnetic powder and resin. In detail, the magnetic core of the embodiment is a casting, which is obtainable by casting the mixture into a predetermined shaped container for molding. In consideration of the size of the high-power coil component, it is preferable that the mixture is composed of the materials which are capable of casting without any solvents.

In this embodiment, the casting process is basically carried out without pressure or with reduction of pressure. Once the casting process is finished, the casting may be subjected to some pressure for the purpose of increasing the density of the magnetic core according to the present embodiment. There is no limitation on the mold shape, and the magnetic core of the mixture can be formed in any shapes.

The magnetic powder is soft magnetic metal powder, especially, Fe base powder in this embodiment. Specifically, the Fe base powder is powder selected from the group comprising Fe—Si system powder, Fe—Si—Al system powder, Fe—Ni system powder and Fe system amorphous powder. In case of Fe—Si system powder, an average content of Si is preferably in a range of from 0.0 percent, by weight, to 11.0 percents, by weight, both inclusive. In case of Fe—Si—Al system powder, an average content of Si is preferably in a range of from 0.0 percent, by weight, to 11.0 percents, by weight, both inclusive; while another average content of Al is preferably in a range of from 0.0 percent, by weight, to 7.0 percents, by weight, both inclusive. In case of Fe—Ni system powder, an average content of Ni is in a range of from 30.0 percents, by weight, to 85.0 percents, by weight, both inclusive.

In this embodiment, the magnetic powder is substantially spherical powder, which can be obtained by, e.g., gas atomization. The spherical or the almost spherical powder is suitable for increasing its filling factor or filling ratio in the mixture of the magnetic powder and the resin. In this embodiment, it is recommended that the spherical or the almost spherical powder has an average diameter of 500 μm or less as the most normal diameter in its particle size distribution. The magnetic powder may be non-spherical powder such as powder obtained by another intentional gas atomization or indefinitely-shaped powder obtained by water atomization, when its anisotropy is used. If the magnetic powder of non-spherical powder or indefinitely-shaped powder is used, the mixture of the magnetic powder and the resin is subjected to an anisotropic alignment under the predetermined magnetic field before the mixture becomes completely hardened.

In this embodiment, the resin is epoxy resin. In this embodiment, the epoxy resin is required to be liquid which has a small coefficient of viscosity. Therefore, the mutual solubility of resin and additives, hardenings or catalysts and the lifetime of the resin, in particular, are important items to be considered in deciding the actual epoxy resin. Based on the considerations, it is preferable that the base compound is selected from the group of bisphenol A epoxy resin, bisphenol F epoxy resin, polyfunctional epoxy resin and so on, while the hardener or curing agent is selected from the group of aromatic polyamine system, carboxylic anhydride system, initiative hardener system and so on. In this embodiment, bisphenol A epoxy resin is selected as a base compound of resin, and low-viscosity solventless aromatic amine liquid is selected as a hardener.

The resin may be another thermosettable resin such as silicone resin. Also, the resin may be another curable or hardenable resin such as light-curable or photo-settable resin, ultraviolet curable resin, chemical-reaction curable resin, or the like.

In consideration of fluidity of the mixture of the resin and the magnetic powder, the mixing ratio of the resin in the mixture is in a range of from 20 percents, by volume, to 90 percents, by volume, both inclusive. Preferably, the mixing ratio is in a range of from 40 percents, by volume, 5 to 70 percents, by volume, both inclusive.

The magnetic core has an elastic modulus of 3000 MPa or more. The resin is selected such that, in case of the magnetic core has the foregoing elastic modulus under a specific condition, the resin has an elastic modulus of 100 MPa or more if only the resin is hardened in accordance with the specific condition. The value of the elastic modulus of the magnetic core or the hardened resin is measured in accordance with a standard of measurement called JIS K6911 (Testing methods for thermosetting plastics).

In this embodiment, the magnetic core has the elastic modulus of 15000 MPa. The resin is selected such that the hardened resin has 1500 MPa if only the resin is hardened under the same condition where the mixture is hardened to have the elastic modulus of 15000 MPa. When the magnetic core has the elastic modulus of 15000 MPa or more, its thermal conductivity drastically becomes better. Specifically the thermal conductivity becomes 2[WK⁻¹m⁻¹]. Therefore, it is preferable that the magnetic core has the elastic modulus of 15000 MPa or more.

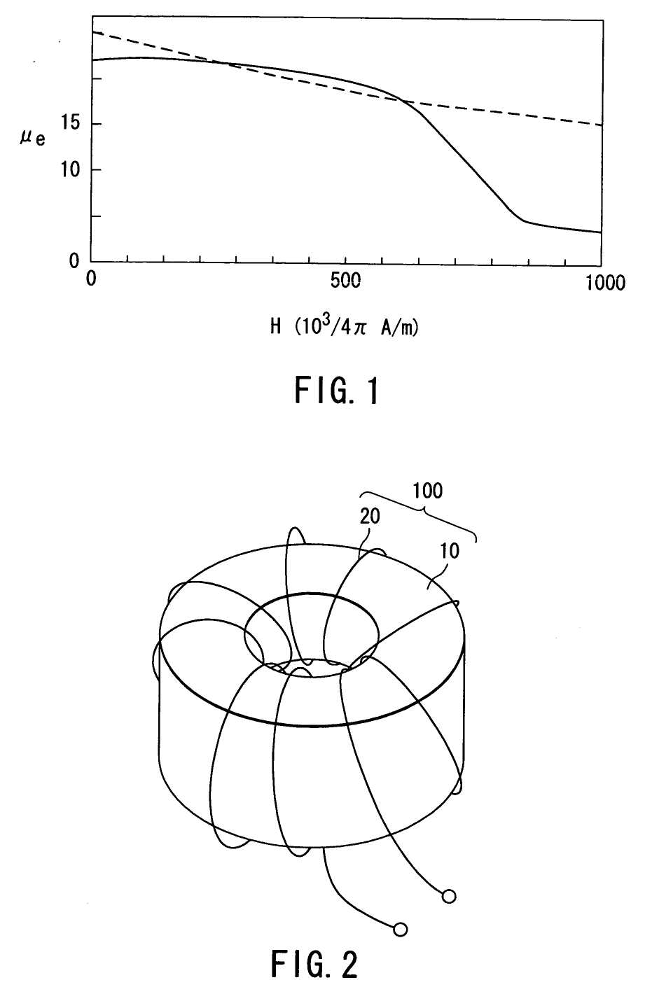

FIG. 1 shows a DC bias characteristic of the magnetic core made of the mixture of Fe—Si system powder and epoxy resin. The mixing ratio of the epoxy resin in the mixture is 50 percents, by volume. Namely, the Fe—Si system powder has mixing ratio of 50 percents, by volume. From FIG. 1, it is clearly seen that the DC bias characteristic of the mixture of the embodiment does not drastically saturated and has high relative permeability μₑ over fifteen even at a magnetic field of 1000*10³/4π [A/m].

The above-mentioned magnetic core can be modified as far as the magnetic core has relative permeability of 10 or more at a magnetic field of 1000*10³/4π [A/m]. For example, each of particles of the magnetic powder may be provided with a high permeability thin layer, such as a Fe—Ni base thin layer. The high permeability thin layer is formed on a surface of each particle of the magnetic powder. Also, each of particles of the magnetic powder may be coated with at least one insulator layer in advance of the mixing of the powder and the resin. In case of the magnetic powder particle with the high permeability thin layer, the insulator layer is formed on the high permeability thin layer. The mixture of the resin and the magnetic powder may further include non-magnetic filler such as filler selected from the group comprising glass fiber, granular resin, and inorganic material base powder, which includes silica powder, alumina powder, titanium oxide powder, silica glass powder, zirconium powder, calcium carbonate powder and aluminum hydroxide powder. Also, the mixture of the resin and the magnetic powder may include a small amount of permanent magnetic powder.

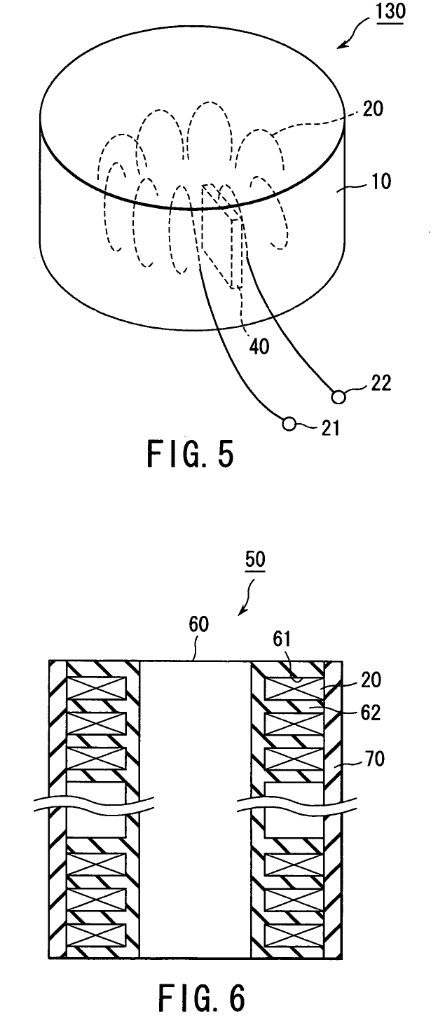

Next explanation will be directed to a coil component using the above-mentioned magnetic core with reference to FIGS. 2 to 8.

A first coil component 100 shown in FIG. 2 is a toroidal magnetic core 10 made of the above-mentioned mixture and a coil 20 wound around the magnetic core 10.

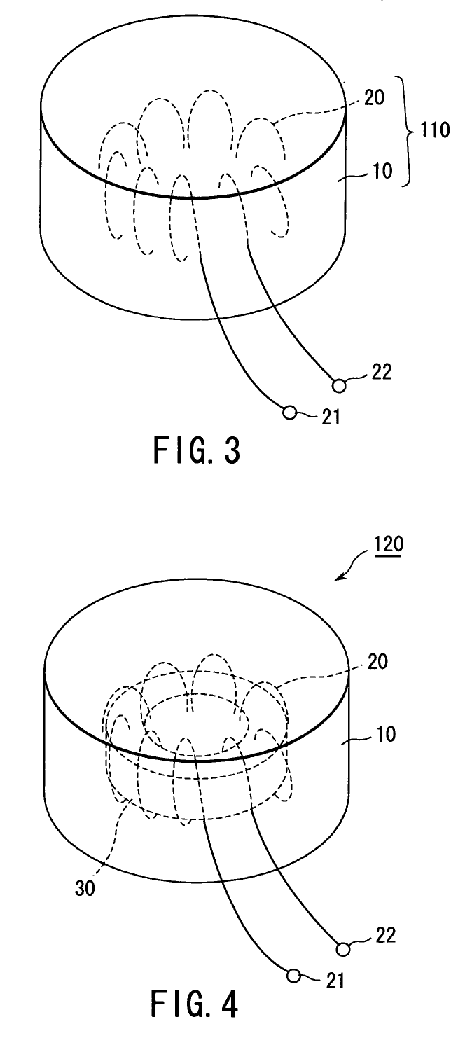

A second coil component 110 shown in FIG. 3 is one of modifications of toroidal coil component. The coil 20 is completely embedded in the magnetic core 10 made of the mixture, except for end portions 21, 22 of the coil 20. The coil 20 may be partially exposed out of the magnetic core 10.

A third coil component 120 shown in FIG. 4 is another modification of toroidal coil component, which comprises a specific magnetic core member 30 in addition to the magnetic core 10 made of the aforementioned mixture and the coil 20. The coil 20 is completely embedded in the magnetic core 10 made of the mixture, except for end portions 21, 22 of the coil 20. The coil 20 is wound around the specific magnetic core 30 which is also completed embedded in the magnetic core 10. As far as the specific magnetic core 30 constitutes one part of the magnetic path in relation to the coil 20, the specific magnetic core 30 can be disposed anywhere. For example, the specific magnetic core member 30 can be disposed around the coil 20 and/or within a hollow portion or inner portion of the coil 20. The hollow portion or inner portion of the coil 20 is also referred to as a magnetomotive force portion.

Preferably, the specific magnetic core member 30 is fixed to the coil 20 by means of the magnetic core 10 made of the mixture. Also, it is preferable that the specific magnetic core member 30 is a dust core made of powder selected from the group comprising Fe system amorphous powder, Fe—Si system powder, Fe—Si—Al system powder and Fe—Ni system powder, or a laminated core made of Fe base thin sheets.

A fourth coil component 130 shown in FIG. 3 is another modification of toroidal coil component, which comprises a high magnetic reluctance member 40. The high magnetic reluctance member 40 has a magnetic reluctance higher than the mixture, i.e. the material of the magnetic core 10. The high magnetic reluctance member 40 is inserted into the magnetic path formed by the coil 20 so that the magnetic fluxes due to the coil 20 penetrate the high magnetic reluctance member 40. In other words, the illustrated high magnetic reluctance member 40 is placed within the hollow portion of the coil 20. The illustrated high magnetic reluctance member 40 is embedded in the magnetic core 10 made of the mixture. For example, the high magnetic reluctance member 40 is made of a material which comprises the same resin as the resin of the mixture. In addition, the high magnetic reluctance member 40 may be made of another material comprising the same resin as the resin of the mixture and magnetic powder as far as the high magnetic reluctance member 40 has the magnetic reluctance higher than the magnetic core 10.

The high magnetic reluctance member 40 constitutes a region which has relative permeability of 20 or less within the magnetic core 10 made of the mixture.

As shown in FIG. 6, the coil 20 may be enclosed by an insulator 50 to ensure insulation between turns of the coil 20. The illustrated insulator 50 comprises a bobbin 60 and a cylindrical cover 70. The bobbin 60 has on its peripheral part thereof a spiral groove 61. Neighboring spiral turns of the groove 61 constitute the separations 62 of the turns of the coil 20. The coil 20 is accommodated in a space defined by the spiral groove 61 and the cylindrical cover 70. Therefore, if there are two or more coils 20, they can be insulated from each other.

Preferably, the material of the insulator 50 is the same resin as that of the mixture. The insulator 50 may be molded by using the same material. In addition, the illustrated coil 20 is an edgewise coil but may be another type coil such as a toroidal coil.

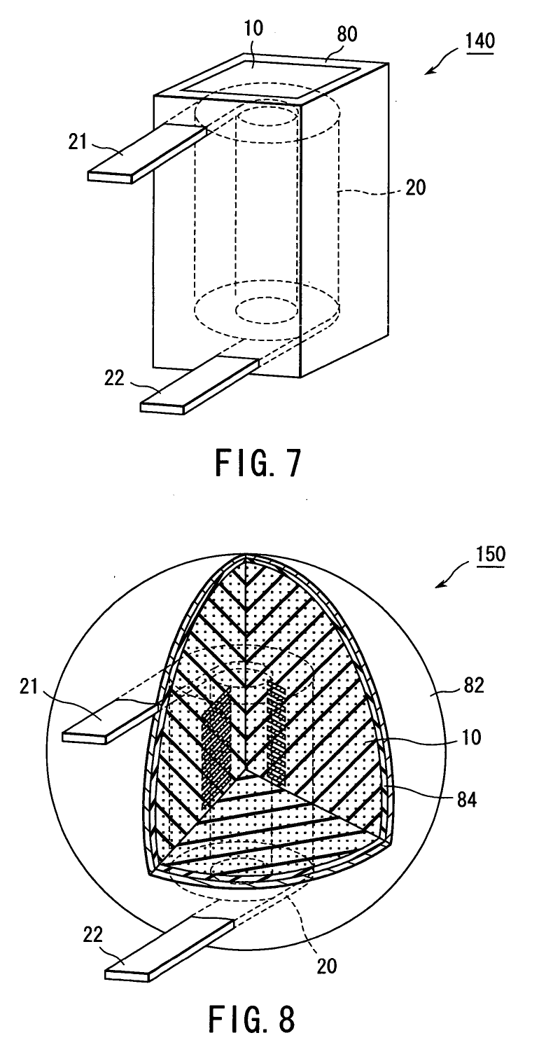

A fifth coil component 140 shown in FIG. 7 further comprises a case 80, which has a rectangular parallelepiped shape, although its upper surface is omitted in FIG. 7 for the sake of better understanding. The coil 20 of the fifth coil component 140 is an edgewise coil. The coil 20 is arranged within the case 80 The magnetic core 10 made of the mixture is filled between the coil 20 and the case 80 and encapsulates the coil 20 therein. For example, the case 80 is made of metal such as aluminum alloy or Fe—Ni alloy. It is preferable that, on the inner surface of the metal case 80, an insulation layer is formed The case 80 may be a ceramic case such as an alumina mold.

A six coil component 150 shown in FIG. 8 also has a case 84 but the shape of the case 84 is spherical. In detail, the case comprises a metal container 82 and an insulator layer 84 formed on the inner surface of the metal container 82. The metal container 82 is made of aluminum alloy or Fe—Ni alloy.

In every coil component 100, 110, 120, 130, 140, 150, the magnetic core 10 made of the mixture constitutes a loop of a magnetic path passing a center of the coil 30. In every coil component 100, 110, 120, 130, 140, 150, the magnetic core 10 constitutes at least one part of a magnetic path in relation to the coil 20.

The preferred embodiments of the present invention will be better understood by those skilled in the art by reference to the above description and figures. The description and preferred embodiments of this invention illustrated in the figures are not to intend to be exhaustive or to limit the invention to the precise form disclosed. They are chosen to describe or to best explain the principles of the invention and its applicable and practical use to thereby enable others skilled in the art to best utilize the invention.

While there has been described what is believed to be the preferred embodiment of the invention, those skilled in the art will recognize that other and further modifications may be made thereto without departing from the sprit of the invention, and it is intended to claim all such embodiments that fall within the true scope of the invention.

1. A magnetic core obtainable by hardening a mixture of magnetic powder and resin, the magnetic core having relative permeability of 10 or more at a magnetic field of 1000*10³/4π [A/m].

2. The magnetic core according to claim 1, having an elastic modulus of 3000 MPa or more.

3. The magnetic core according to claim 2, wherein, in case of the magnetic core has the foregoing elastic modulus under a specific condition, the resin has an elastic modulus of 100 MPa or more if only the resin is hardened in accordance with the specific condition.

4. The magnetic core according to claim 1, wherein the magnetic powder is soft magnetic powder.

5. The magnetic core according to claim 4, wherein the soft magnetic powder is soft magnetic metal powder.

6. The magnetic core according to claim 5, wherein the soft magnetic metal powder is Fe—Si system powder.

7. The magnetic core according to claim 6, wherein an average content of Si in the Fe—Si system powder is in a range of from 0.0 percent, by weight, to 11.0 percents, by weight, both inclusive.

8. The magnetic core according to claim 5, wherein the soft magnetic metal powder is Fe—Si—Al system powder.

9. The magnetic core according to claim 8, wherein an average content of Si in the Fe—Si—Al system powder is in a range of from 0.0 percent, by weight, to 11.0 percents, by weight, both inclusive, and another average content of Al in the Fe—Si—Al system powder is in a range of from 0.0 percent, by weight, to 7.0 percents, by weight, both inclusive.

10. The magnetic core according to claim 5, wherein the soft magnetic metal powder is Fe—Ni system powder.

11. The magnetic core according to claim 10, wherein an average content of Ni in the Fe—Ni system powder is in a range of from 30.0 percents, by weight, to 85.0 percents, by weight, both inclusive.

12. The magnetic core according to claim 5, wherein the soft magnetic metal powder is Fe system amorphous powder.

13. The magnetic core according to claim 1, wherein the magnetic powder is substantially spherical powder.

14. The magnetic core according to claim 1, wherein each of particles of the magnetic powder is provided with a high permeability thin layer, which is formed on a surface of each particle of the magnetic powder.

15. The magnetic core according to claim 14, wherein the high permeability thin layer is a Fe—Ni base thin layer.

16. The magnetic core according to claim 1, wherein each of particles of the magnetic powder is coated with at least one insulator layer in advance of the mixing of the powder and the resin.

17. The magnetic core according to claim 1, wherein the resin is a curable or hardenable resin.

18. The magnetic core according to claim 17, wherein the curable resin is a thermosettable resin.

19. The magnetic core according to claim 18, wherein the resin is epoxy resin or silicone resin.

20. The magnetic core according to claim 1, wherein a mixing ratio of the resin in the mixture is in a range of from 30 percents, by volume, to 90 percents, by volume, both inclusive.

21. The magnetic core according to claim 20, wherein the mixing ratio is in a range of from 50 percents, by volume, to 70 percents, by volume, both inclusive.

22. The magnetic core according to claim 1, wherein the mixture includes non-magnetic filler.

23. The magnetic core according to claim 1, being a casting obtainable by casting the mixture.

24. The magnetic core according to claim 23, wherein the mixture is composed of materials which are capable of casting without any solvents.

25. A coil component comprising: the magnetic core according to claim 1; and a coil wound around the magnetic core.

26. A coil component comprising: the magnetic core according to claim 1; and a coil, wherein the magnetic core is arranged in the vicinity of the coil to constitute at least one part of a magnetic path in relation to the coil.

27. A coil component comprising: the magnetic core according to claim 1; and a coil, wherein at least one part of the coil is embedded in the magnetic core.

28. The coil component according to claim 27, wherein the coil is completely embedded in the magnetic core, except for end portions of the coil.

29. The coil component according to claim 25, further comprising a specific magnetic core member disposed around the coil and/or within a hollow portion of the coil.

30. The coil component according to claim 29, wherein the specific magnetic core member is fixed to the coil by means of the magnetic core made of the mixture.

31. The coil component according to claim 29, wherein the specific magnetic core member is a dust core made of powder selected from the group comprising Fe system amorphous powder, Fe—Si system powder, Fe—Si—Al system powder and Fe—Ni system powder, or a laminated core made of Fe base thin sheets.

32. The coil component according to claim 27, further comprising a high magnetic reluctance member, which has a magnetic reluctance higher than the mixture and is embedded in the magnetic core made of the mixture.

33. The coil component according to claim 32, wherein the high magnetic reluctance member is made of a material comprising the same resin as the resin of the mixture.

34. The coil component according to claim 32, wherein the high magnetic reluctance member is placed within the hollow portion.

35. The coil component according to claim 32, wherein the high magnetic reluctance member constitutes a region which has relative permeability of 20 or less within the magnetic core made of the mixture.

36. The coil component according to claim 27, wherein the magnetic core made of the mixture constitutes a loop of a magnetic path passing a center of the coil.

37. The coil component according to claim 27, further comprising a case, wherein: the coil is arranged within the case; and the magnetic core made of the mixture is filled between the coil and the case and encapsulates the coil therein.

38. The coil component according to claim 37, wherein the case comprises a metal container and an insulator layer formed on an inner surface of the metal container, or
wherein the case comprises a ceramic container.

39. The coil component according to claim 38, wherein the metal container is made of aluminum alloy or Fe—Ni alloy.

40. The coil component according to claim 38, wherein the ceramic container is an alumna mold.

41. A coil component comprising: a magnetic core obtainable by hardening a mixture of magnetic powder and resin; and a coil wound on a periphery of the magnetic core.
